(19) United States
(12) Patent Application Publication
(10) Pub. No.: US 2025/0313667 A1
(43) Pub. Date: Oct. 9, 2025

(54) A FAMILY OF THERMOGELLING CATIONIC COPOLYMERS CONTAINING POLYETHYLENIMINE AND POLYPROPYLENE GLYCOL

(71) Applicant: Agency for Science, Technology and Research, Singapore (SG)

(72) Inventors: Xian Jun LOH, Singapore (SG); Yuan Chong Jason LIM, Singapore (SG); Qianyu LIN, Singapore (SG)

(21) Appl. No.: 18/864,641

(22) PCT Filed: May 9, 2023
(86) PCT No.: PCT/SG2023/050321

§ 371 Date: Nov. 11, 2024

(30) Foreign Application Priority Data
May 10, 2022 (SG) 10202204903S

(51) Int. Cl. C08G 73/02

(52) U.S. Cl. CPC C08G 73/024

(57) ABSTRACT

Described herein are compositions containing branched polyethylenimine and polypropylene glycol covalently bonded to the branched polyethyleneimine, where a molar ratio of the propylene glycol to the branched polyethylenimine is more than 3.35:1, and the polypropylene glycol is hydrophobic. The compositions may be used as a hydrogel and changes between a solution phase and a gel phase by changes in pH or temperature.

The present application claims priority to Singapore patent application number 10202204903S titled “Cationic Polyethylenimine-derived pH and Temperature-responsive Hydrogel” filed on 10 May 2022 which is incorporated by reference herein in its entirety.

### TECHNICAL FIELD

The present disclosure relates to polymer compositions that are able to form hydrogels which are sensitive to temperature and pH.

### BACKGROUND

Hydrogels are a class of soft materials formed by polymeric matrixes entrapping large amounts of water.[1] Numerous hydrogels of wide ranging compositions and formulations have been developed via various synthetic routes and they have demonstrated high potential in many niche biomedical applications.[2] Among hydrogels, stimuli-responsive hydrogels such as those responsive to temperature[3], pH,[4] glucose,[5] enzyme,[6] and carbon dioxide[7] are especially attractive due to their advanced functionality to respond to their environment. These stimuli-responsive hydrogels may be chemically or physically crosslinked.[8]

Temperature responsive hydrogels, also known as thermogels, are a specific group of stimuli-responsive physically crosslinked supramolecular hydrogels with reversible sol-gel phase transitions.[9] Thermogels are comprised of amphiphilic copolymers that form micelles in solution and the aggregation of micelles when heated produces the hydrogel matrix and leads to sol-gel phase transition.[10] These thermogelling amphiphilic copolymers are commonly synthesized by conjugating various hydrophilic polymers such as polyethylene glycol (PEG) and poly(N-isopropylacrylamide) (PNIPAAm) with temperature sensitive polymers like polypropylene glycol (PPG) and poly(lactic-co-glycolic acid) (PLGA).[11] Thermogels are high potential biomedical materials. They are commonly demonstrated as highly effective in-situ gelling depot for sustained drug or protein delivery and more recently our group has shown that they can also be employed as effective vitreous endotamponades.[12]

Thermogels are a class of unique soft materials that have a number of very useful biomedical applications. By virtue of their temperature-responsiveness, they have been applied for sustained localised drug delivery, tissue engineering and even as injectable vitreous substitutes to facilitate ophthalmic post-surgical recovery. However, the vast majority of available thermogelling systems are electro-neutral (i.e. not charged) and are restricted largely to PEG-containing polymers. These PEG containing polymers are restricted in the extent of tunability of their properties: for example, modulation of thermogel properties (e.g. biodegradability) and require the addition of increasing numbers of copolymeric components. This makes it inherently difficult to engineer and achieve multiple stimuli-responsiveness. However, these thermogelling systems are overwhelmingly based on neutral copolymers while polyelectrolyte thermogels remain unexplored and their potential untapped.

On the other hand, polyelectrolyte micelles have been extensively researched and they are commonly polycationic amphiphilic copolymers based on polyethylenimine (may be alternatively spelled as polyethyleneimine) (PEI).[13] They have been shown to possess advanced anti-bacterial properties[14] and gene-transfection[15] capability. Yet, none of these polyelectrolyte micelles have been demonstrated to have the ability to undergo self-assembly and achieve sol-gel phase transition. The applications of these polyelectrolyte PEI micelles are often limited by their inability to form localised gel depots.[16]

### SUMMARY

In a first aspect, there is provided a composition comprising branched polyethylenimine and polypropylene glycol covalently bonded to the branched polyethyleneimine, wherein a molar ratio of the propylene glycol to the branched polyethylenimine is more than 3.35:1, and the polypropylene glycol is hydrophobic.

Preferably, a first end of the propylene glycol is capped with an aliphatic group, an aryl group, or an aralkyl group in any combinations thereof, and a second end of the propylene glycol is covalently bonded to the branched polyethyleneimine. Whilst it may be simpler both in terms of synthesis and characterisation, it is not necessary for a single cap group to be used. In an embodiment, the propylene glycol is capped with the aliphatic group, preferably an alkyl group, more preferably a C1 to C6 alkyl group. The term C1 alkyl group refers to an alkyl group having one carbon atom (e.g. methyl), a C2 alkyl group having two carbon atoms (e.g. ethyl) and so forth including all possible chain isomers. In an example, n-butyl is used as the cap group. Advantageously, the capped propylene glycol can only bond to one molecule of the branched polyethyleneimine and provides more control over the preparation of the polymer composition.

Preferably, the propylene glycol has a number average molecular weight of at least 500 Da, preferably from 500 Da to 20 kDa, more preferably from 1 kDa to 10 kDa.

Preferably, the branched polyethyleneimine has a weight average molecular weight of at least 500 Da, preferably from 500 Da to 50 kDa, more preferably from 5 kDa to 50 kDa. In an embodiment, the branched polyethyleneimine has a weight average molecular weight from 10 kDa to 40 kDa.

Preferably, the branched polyethylenimine has a degree of branching from 5% to 50%. In another embodiment, the polyethyleneimine has a degree of branching from 10% to 40%. In another embodiment, the polyethyleneimine has a degree of branching from 15% to 30%. In another embodiment, the polyethyleneimine has a degree of branching from 15% to 25%.

Preferably, the propylene glycol is covalently bonded to the branched polyethyleneimine via a functional group selected from the group consisting of a carbamate, a carbonate, a carbamide, an ester, an amide, an ether, an amine, a triazole, and any combinations thereof, preferably the carbamate, the amide, the ether, the amine, the triazole, and any combinations thereof. Whilst it may be simpler both in terms of synthesis and characterisation, it is not necessary for a single functional group to be used to join the polypropylene glycol to the branched polyethyleneimine.

Preferably, the molar ratio of the polypropylene glycol to the branched polyethyleneimine is from more than 3.35:1 to 60:1, preferably the molar ratio is from more than 3.35:1 to 50:1, more preferably the molar ratio is from more than 3.35:1 to 40:1. The molar ratio of the polypropylene glycol to the branched polyethyleneimine is a macroscopic property and may be viewed as an average hence need not be an integer value. At the microscopic level, for example each molecule of the branched polyethyleneimine may be bonded to one or more molecules of polypropylene glycol, it is the overall amount of polypropylene glycol bonded that may be measured as described by the examples herein and in the art.

In an embodiment, the branched polyethyleneimine is unquarternised, and the molar ratio of propylene glycol to branched polyethylenimine is from more than 3.35:1 to 40:1, preferably the molar ratio is from 7:1 to 35:1, more preferably the molar ratio is from 10:1 to 25:1. Preferably, the molar ratio of the hydrophobic polymer to the cationic polymer is from 15:1 to 20:1, preferably the molar ratio is from 17:1 to 19:1. In this embodiment, the branched polyethyleneimine in the composition may have primary, secondary, and/or tertiary amines.

In an embodiment, the branched polyethylenimine comprises from 1 mol % to 50 mol % of nitrogen atoms quarternised with a second aryl group, a second aliphatic group, or a second aralkyl group in any combinations thereof, and the molar ratio of propylene glycol to polyethylenimine is more than 8.13:1, preferably the polyethylenimine comprises 1 mol % to 30 mol % of nitrogen atoms quarternised. In an embodiment, the molar ratio of propylene glycol to polyethylenimine is from more than 8.13:1 to 60:1, preferably the molar ratio is from 15:1 to 60:1, more preferably the molar ratio is from 15:1 to 50:1, even more preferably the molar ratio is from 15:1 to 40:1. In this embodiment, the branched polyethyleneimine component in the composition may have primary, secondary, tertiary amines, and quartenary amines. Advantageously, the formation of quaternary ammonium cations allows for further tuning of the physical properties and characteristics of the polymer composition and thereby the hydrogel formed.

In an embodiment, the composition essentially excludes polyethylene glycol. Preferably, the composition excludes polyethylene glycol.

In an embodiment, the composition further comprises a third polymer up to 20 weight percent of the composition, wherein the third polymer is different from the hydrophobic polymer and the cationic polymer or different from polyethylenimine and polypropylene glycol. The third polymer may be a synthetic or natural polymer and may be used as a partial substitute of the polypropylene glycol and the branched polyethyleneimine. Some examples that may be used as the third polymer to replace part of the branched polyethyleneimine include linear polyethylenimine, poly(2-(dimethylamino)ethyl methacrylate), a poly(beta-amino ester), and any combinations thereof. Some examples that may be used as the third polymer to replace part of the propylene glycol include polylactic acid, poly(lactic-co-glycolic acid), polycaprolactone, polyhydroxybutyrate, and any combinations thereof. Examples of natural polymers that may be used include chitosan, hyaluronic acid, cellulose, amino acids, DNA segments, and cholesterol.

In an embodiment, polyethylenimine and polypropylene glycol are the only polymers present. In an embodiment, the composition consists essentially of branched polyethylenimine and polypropylene glycol, preferably the composition consists of branched polyethylenimine and polypropylene glycol.

In an embodiment, the composition further comprises water, and preferably a buffer solution. The polymer compositions described herein changes between a solution phase and a gel phase based on changes in the temperature and/or pH.

In an embodiment, the composition further comprises at least one of the following: a therapeutic agent, a protein, and a nucleic acid sequence.

In a second aspect, there is provided a use of the composition according to the first aspect in the capture of carbon dioxide or in the recovery of a metal from waste. In an embodiment, the composition of the first aspect above may be for use as a medicament. In an embodiment, the composition of the first aspect above may be used in the manufacture of a medicament.

Advantageously, the compositions allow a thermogel to be formed that is able to change between a solution phase and a gel phase based on temperature and/or pH. Further, by changing the ratio of the polypropylene glycol to the branched polyethyleneimine, the properties of the resultant gel may be tuned. The properties of the gel may be further tuned by forming quaternary ammonium cations in the polyethyleneimine moiety.

### DESCRIPTION

In the Figures:

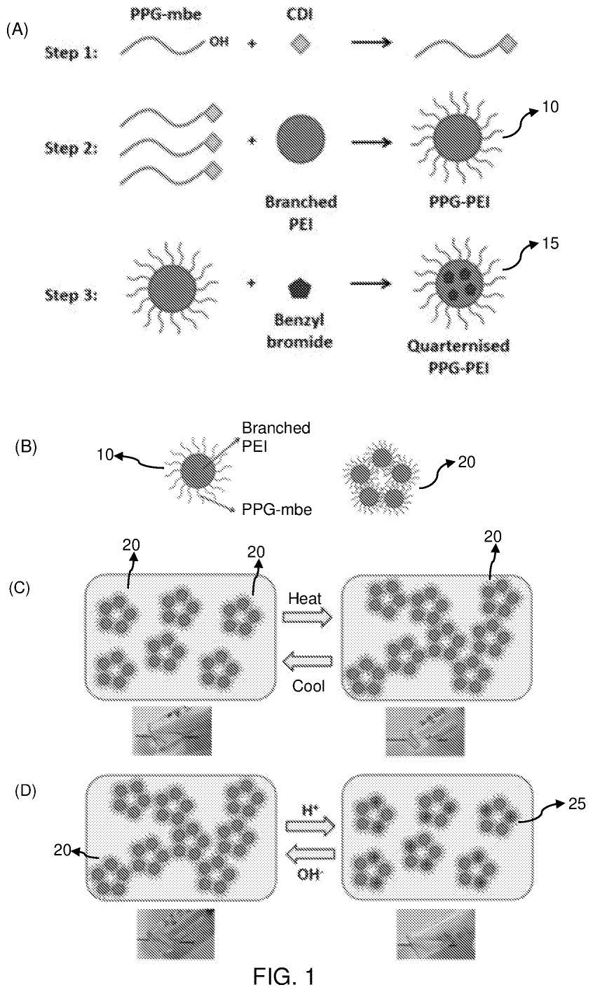

Figure (FIG. 1 shows an overview of the preparation of the PPG-branched PEI polymer composition and the formed micelles. Panel A shows a schematic representation of the synthesis of the synthesis of poly(PEI/PPG-mbe urethane) copolymers and quarterisation; Panel B shows a schematic representation of the poly(PEI/PPG-mbe urethane) copolymer on the left and a proposed mechanism of formation of micelles on the right; Panels C and D show the self-assembly of the PPG-PEI cationic copolymers into supramolecular hydrogel with temperature and pH respectively.

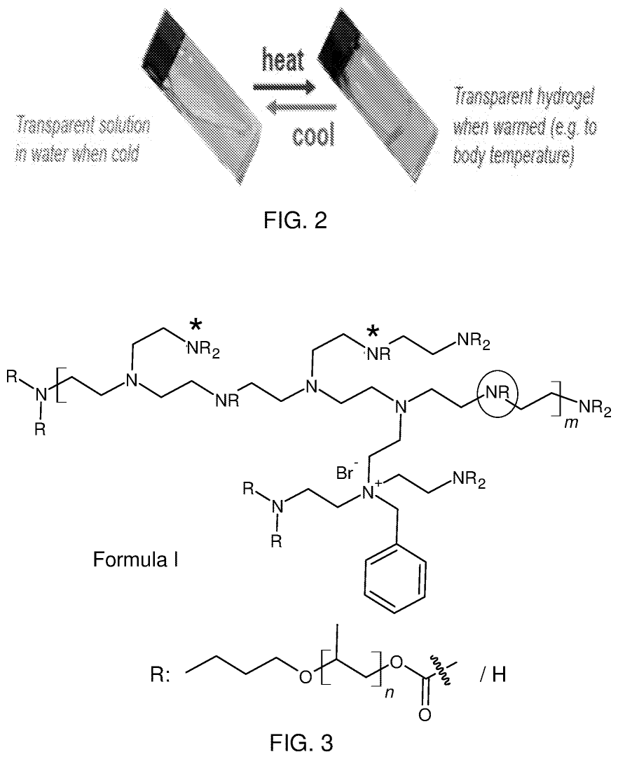

FIG. 2 shows an example of a thermogel.

FIG. 3 shows a representative formula of the poly(PEI/PPG-mbe urethane) copolymer with the quarternised ammonium species.

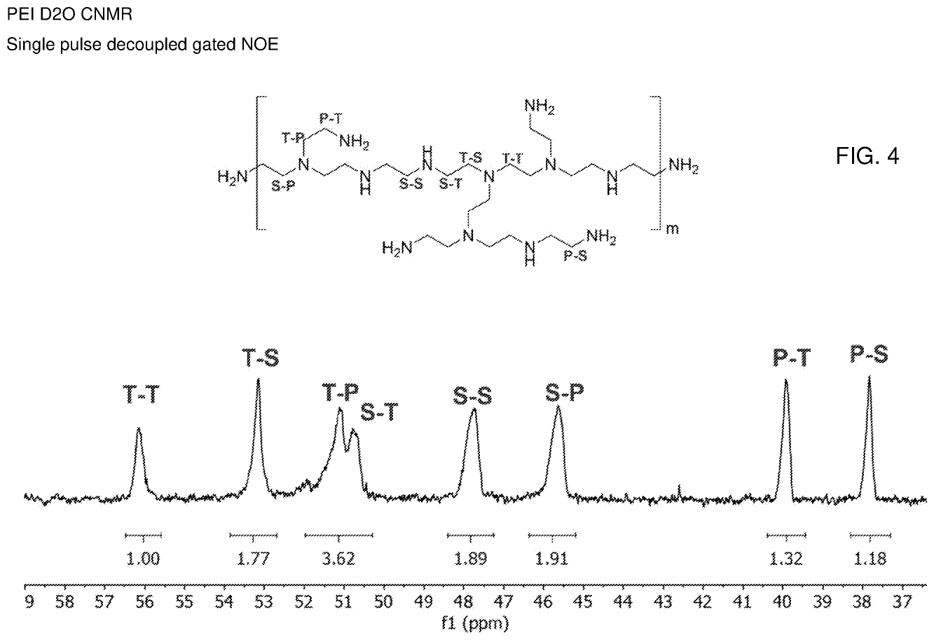

FIG. 4 shows a carbon NMR spectrum of the branched polyethyleneimine used.

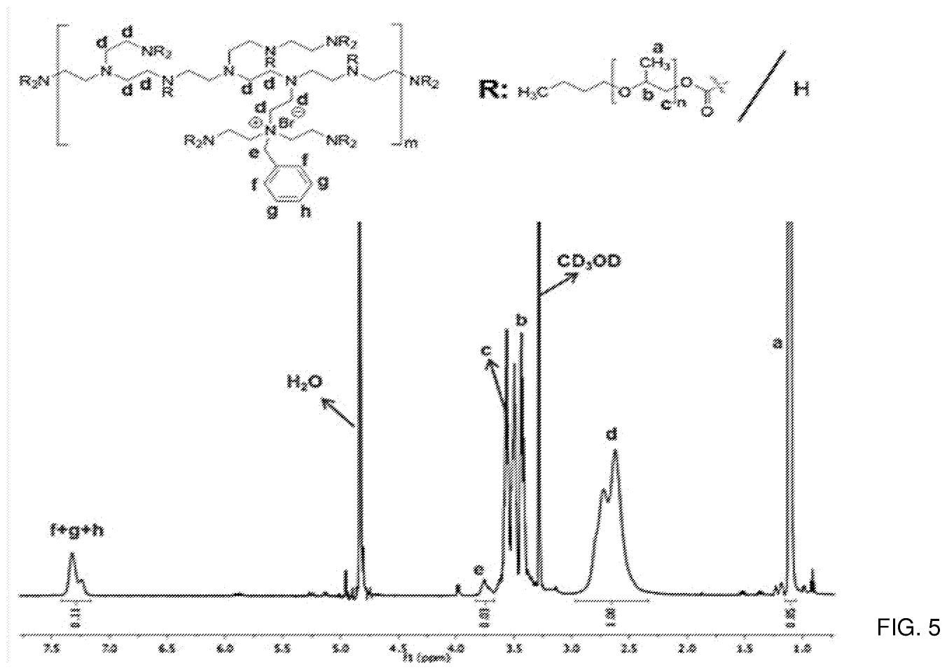

FIG. 5 shows a representative proton NMR spectrum of poly(PPG/PEI urethane) copolymer with quarterisation using benzyl bromide (PCPN 15.8) performed in deuterated methanol.

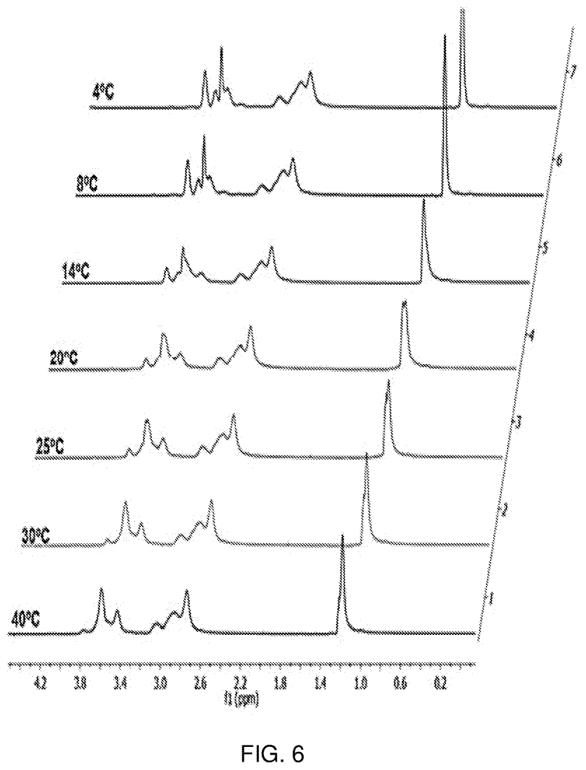

FIG. 6 shows temperature sweep proton NMR spectra of a representative PPG-PEI micelle sol in D₂O.

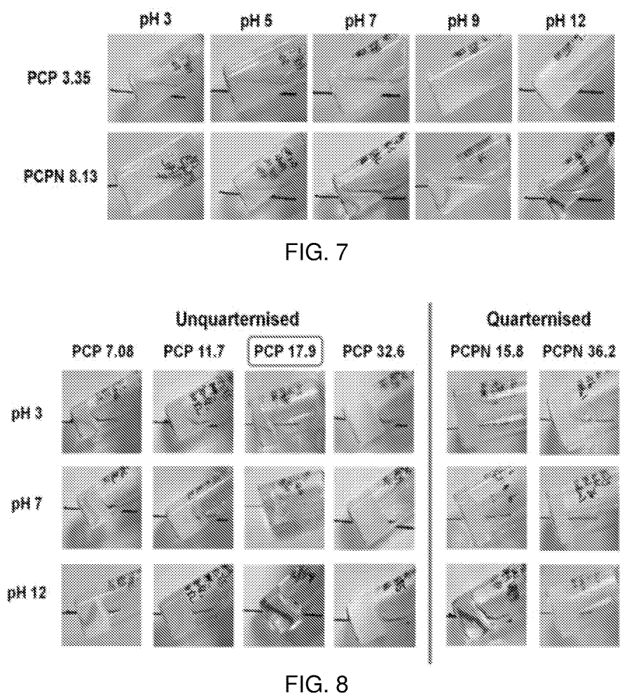

FIG. 7 shows PCP 3.17 and PCPN 8.13 at 20 wt % are unable to achieve sol-gel phase transition as their PPG-mbe content per unit PEI are below the minimum thresholds.

FIG. 8 shows the optical transparencies of various examples of PPG-PEI thermogels at 20 wt %.

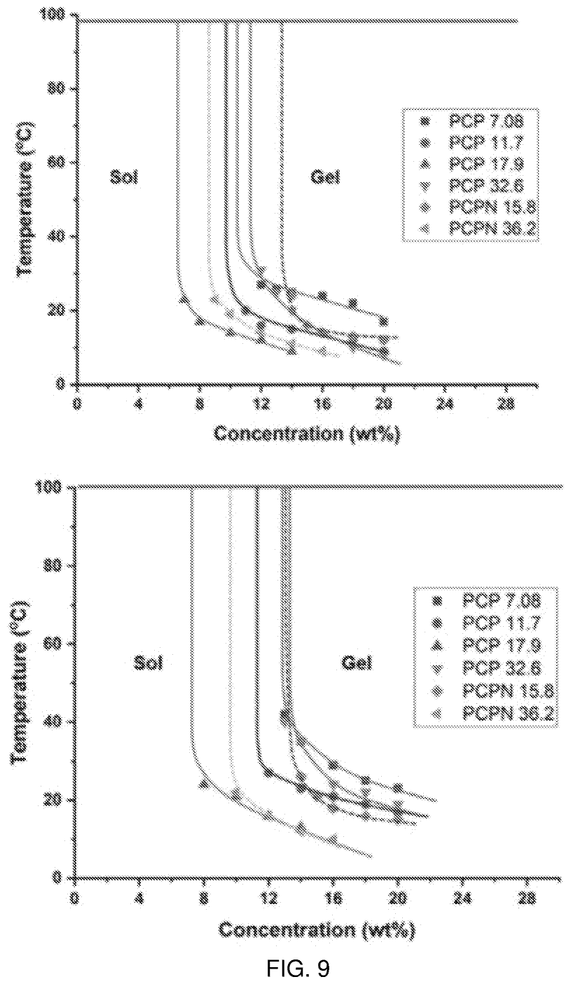

FIG. 9 shows the phase diagrams of various examples of PPG-PEI thermogels at pH 12 (top) and pH 7 (bottom).

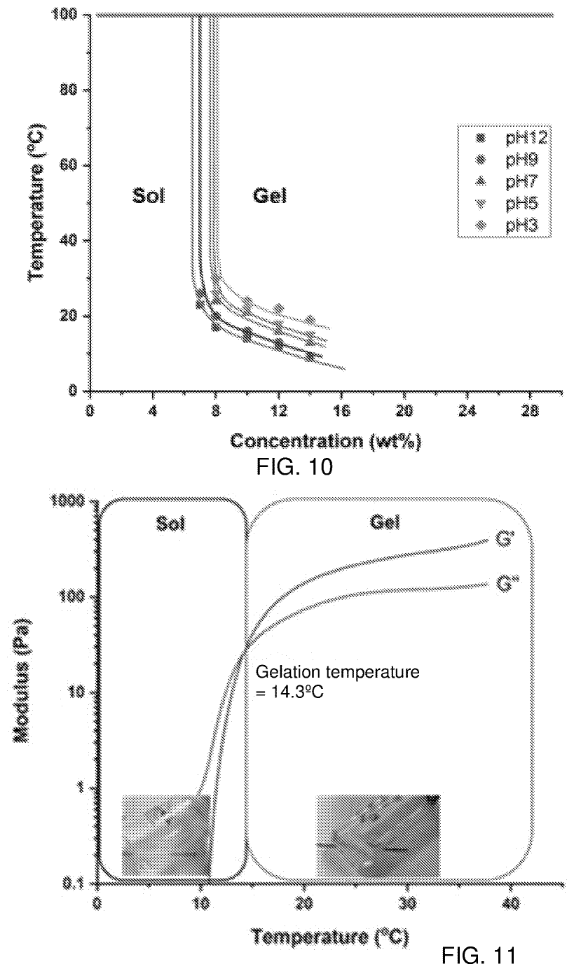

FIG. 10 shows the phase diagrams of the PCP 17.9 thermogel at different pH.

FIG. 11 shows a representative temperature sweep rheological measurement of PCP 17.9 thermogel at 15 wt %.

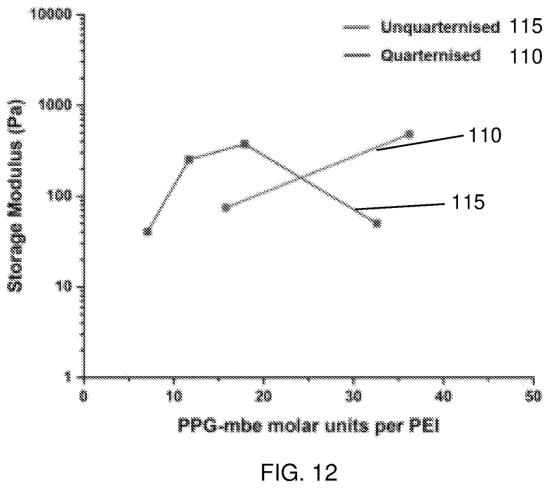

FIG. 12 shows the gel storage moduli (G′) of unquarternised and quarternised PPG-PEI gels (15 wt %) at pH 7 and 37° C.

Unless defined otherwise, all technical and scientific terms used herein have the meaning commonly understood by a person skilled in the art to which this invention belongs.

In the following description, numerous specific details are set forth in order to provide a thorough understanding of various illustrative embodiments of the invention. It will be understood, however, to one skilled in the art, that embodiments of the invention may be practiced without some or all of these specific details. Embodiments described in the context of one of the methods or products are analogously valid for the other methods or products. Similarly, embodiments described in the context of a method are analogously valid for a product, and vice versa.

The terms “about”, “approximately”, “substantially” must be read with reference to the context of the application as a whole and have regard to the meaning a particular technical term qualified by such a word usually has in the field concerned. For example, it may be understood that a certain parameter, function, effect, or result can be performed or obtained within a certain tolerance, and the skilled person in the relevant technical field knows how to obtain the tolerance of such term.

The phrase “at least one of A and B” means it requires only A alone, B alone, or A and B, i.e. only one of A or B is required. The phrase “A and/or B” includes A alone, B alone and A and B.

As used herein, the articles “a”, “an” and “the” as used regarding a feature or element include a reference to one or more of the features or elements. As used herein, the term “and/or” includes any and all combinations of one or more of the associated listed items. As used herein, the terms “first,” “second,” and “third,” etc. are used merely as labels, and are not intended to impose numerical requirements on their objects. As used herein, the terms “top”, “bottom”, “left”, “right”, “side”, “vertical” and “horizontal” are used to describe relative arrangements of the elements and features. As used herein, the term “each other” denotes a reciprocal relation between two or more objects, depending on the number of objects involved.

Terms such as “connected”, “attached”, “conjugated”, and “linked” are used interchangeably herein and encompass direct as well as indirect connection, attachment, linkage, or conjugation unless the context clearly dictates otherwise.

Where a combination is disclosed, each subcombination of the elements of that combination is also specifically disclosed and is within the scope of the invention. Conversely, where different elements or groups of elements are disclosed, combinations thereof are also disclosed. Where any element of an invention is disclosed as having a plurality of alternatives, examples of that invention in which each alternative is excluded singly or in any combination with the other alternatives are also hereby disclosed; more than one element of an invention can have such exclusions, and all combinations of elements having such exclusions are hereby disclosed.

Although each of these terms has a distinct meaning, the terms “comprising”, “consisting of” and “consisting essentially of” may be interchanged for one another throughout the instant application. The term “having” has the same meaning as “comprising” and may be replaced with either the term “consisting of” or “consisting essentially of”.

Where a range of values is recited, it is to be understood that each intervening integer value, and each fraction thereof, between the recited upper and lower limits of that range is also specifically disclosed, along with each subrange between such values. The upper and lower limits of any range can independently be included in or excluded from the range, and each range where either, neither or both limits are included is also encompassed within the invention. Where a value being discussed has inherent limits, for example where a component can be present at a concentration of from 0 to 100%, or where the pH of an aqueous solution can range from 1 to 14, those inherent limits are specifically disclosed. Where a value is explicitly recited, it is to be understood that values which are about the same quantity or amount as the recited value are also within the scope of the invention, as are ranges based thereon.

The pH values described herein are based on a temperature of 25° C. unless otherwise stated or as understood from the context.

The term “aliphatic group” or “aliphatic” refers to a moiety that may be saturated (e.g. single bond) or contain one or more units of unsaturation, e.g., double and/or triple bonds, and refers to the carbon atom forming the bond. An aliphatic group may be straight chained, branched, or cyclic, contain carbon, hydrogen or, optionally, one or more heteroatoms and may be substituted or unsubstituted. Non-limiting examples of substituents include a halogen, a hydroxyl, an ether, an amine, a carbamate, a carbonate ester, a urea, an aryl group (e.g. benzyl, phenyl ethyl and the like), a carbonyl, a carboxylic acid, an ester, an amide, a cyano, a nitro, a thiol, a sulfoxide, and a sulfone. It is understood that the substituent may be further substituted.

The term “aryl group” refers to a moiety which includes carbocyclic aromatic rings and heteroaryl rings (nitrogen, oxygen, and sulphur and the like), and refers to the atom forming the bond being part of the ring structure. The term “aromatic group” may be used interchangeably with the terms “aryl”, “aryl ring”, “aromatic ring”, “aryl group” and “aromatic group”. The aryl group may be substituted at any one or more substitutable ring atom. Non-limiting examples of substituents include a halogen, a hydroxyl, an ether, an amine, a carbamate, a carbonate ester, a urea, an aliphatic group (e.g. tolyl, mesityl) an aryl group (e.g. biphenyl), a carbonyl, a carboxylic acid, an ester, an amide, a cyano, a nitro, a thiol, a sulfoxide, and a sulfone. It is understood that the substituent may be further substituted.

The term “aralkyl” refers to a moiety in which one or more hydrogens in an aliphatic group are replaced by an equivalent number of an aryl group. The aliphatic and/or aryl group is as described above.

The terms “quarternised” and “quarterisation” refers to the formed and formation of a quarternary ammonium cation (a nitrogen atom covalently bonded to four other aliphatic, aryl or aralkyl groups) and may be termed a quarternary amine. The term “quarternary” and its other forms may be spelled as “quaternary”. The term “unquarternised” refers to non-quarternary amines which include primary, secondary, or tertiary amines.

Disclosed herein are PPG-bPEI thermogels which constitute a new class of polyelectrolyte supramolecular hydrogels that greatly expands the oeuvre of polymers with thermogelling properties. The complete replacement of PEG with branched PEI (bPEI) opens new possibilities in applications by combining temperature and pH responsiveness. PEI may be used to refer to branched PEI herein unless otherwise stated or as understood from the context. Furthermore, the reactivity of the nitrogen atoms on bPEI allow them to be easily functionalised without the need for (multiple) additional sub-components. Other than the advantages of reversible gelation, optical transparency and injectability, PPG-bPEI thermogels offers the potential for advanced biomedical applications such as antimicrobial effects, protein encapsulation, and gene delivery.

Polyelectrolyte thermogels have been developed to combine in synergy the advantages of thermogels and polyelectrolyte micelles and are described herein including the synthesis process of examples of polycationic branched PEI based pH and thermo-responsive supramolecular hydrogel and their properties.

An unprecedented family of amphiphilic positively-charged polymers that are able to dissolve in water to form solutions that can form gels spontaneously when warmed. The polymers are formed from branched polyethyleneimine attached to propylene glycol. The resulting gels are known as thermogels as they exhibit a reversible phase change from flowable solutions to solid like gels triggered by changes in temperature, and pH as well for the thermogel described herein.

The polymer composition contains a core of a cationic polymer with a hydrophobic polymer covalently bonded to the core of the cationic polymer. Each molecule of the cationic polymer is bonded to one or more molecules of the hydrophobic polymer.

In various embodiments, these branched polymers comprise of a hydrophilic core made up of branched polyethylenimine (bPEI) covalently joined to hydrophobic polypropylene glycol monobutyl ether (PPG-mbe) segments via urethane linkages with carboxydiimidazole (CDI) (FIG. 1 panel A). Linear polyethyleneimine may be used in place of bPEI.

In various embodiments, the bPEI may have a weight average molecular weight of at least 500 Da, or at least 1 kDa, or at least 10 kDa, preferably at least 15 kDa, more preferably at least 20 kDa. In various embodiments, the bPEI may have a weight average molecular weight from 500 Da to 50 kDa, preferably from 5 kDa to 50 kDa, more preferably from 10 kDa to 50 kDa, or from 15 kDa to 40 kDa, or from 20 kDa to 30 kDa. An example of the bPEI used may have a weight average molecular weight of 25 kDa,

In various embodiments, the bPEI may have varying degree of branching up to 50%, or from 5% to 50%, or from 10% to 40%, or from 15% to 30%, or from 15% to 25%. The degree of branching may be estimated by comparing the integration ratio of tertiary amines to the total number of amines present in a Nuclear Magnetic Resonance (NMR) spectrum of the bPEI. Thus, the percentage of tertiary amines in the bPEI used may be up to 50%, or from 5% to 50%, or from 10% to 40%, or from 15% to 30%, or from 15% to 25%.

In various embodiments, the polypropylene glycol may have a number average molecular weight of at least 500 Da, or of at least 1 kDa, preferably at least 1.5 kDa, more preferably at least 2 kDa. In various embodiments, the polypropylene glycol may have a number average molecular weight from 500 Da to 20 kDa. Preferably, the propylene glycol has a number average molecular weight from 1 kDa to 10 kDa, or from 1 kDa to 5 kDa, preferably from 1.5 kDa to 4 kD, more preferably from 2 kDa to 3 kDa. An example of the PPG used may have a number average molecular weight of 2.5 kDa.

In various embodiments, the propylene glycol may have one end capped to ensure that each propylene glycol moiety is bonded to one bPEI core. The propylene glycol may be capped at one end with an aliphatic group, an aryl group, or an aralkyl group with the other end covalently bonded to the branched polyethylenimine.

The bPEI may be covalently bonded to PPG by any suitable functional group. Examples of functional groups that may be used include carbamate, carbonate, carbamide, ester, amide, ether, amine, and any combinations thereof. The carbamate, amide, ether, amine, and triazole functional groups may be preferred as these are less reactive and may be able to withstand a larger range of conditions that the copolymer composition and formed gel may be subjected to. It is preferred that the bPEI is bonded directly to the PPG via a functional group, as the use of hexamethylene diisocyanate (HMDI) as the coupling agent resulted in a copolymer that is insoluble in water and no thermogel was formed possibly due to the additional hexyl linker. The bPEI and/or PPG may be functionalised accordingly to allow for the different functional groups to be introduced. The use of the carbamate linker is described herein in greater detail below. In an example, an amide may be introduced by converting a free hydroxyl group in PPG-mbe to a carboxylic acid which may be reacted with the amine in bPEI to form an amide. In an example, the free hydroxyl group in PPG-mbe may be oxidised to an aldehyde and a reductive animation with the amine in bPEI performed to obtain the amine functional group. A triazole may be prepared by click chemistry by introducing the azide to either the PPG or bPEI unit and the alkyne to the other unit. The two components may be reacted under click chemistry conditions to form the triazole. Having a common functional group to attach the PPG units to bPEI may simplify the synthesis but is not necessary. The described examples are merely exemplary and other methods to covalently bond PPG to bPEI may be used.

Spontaneous gelation of the cationic polymer solutions occurs when the PPG-mbe segments of the individual polymer molecules 10 dehydrate when warmed. This is likely to cause the hydrogen bonds between the water molecules and PPG-mbe to break and the water molecule is detached from the PPG-mbe component. It is believed that this is due to the hydrophobic nature of PPG. This causes self-assembly of the polymers 10 to form micelles 20 (FIG. 1 Panel B), which pack together when warmed further to form a gel (FIG. 1 Panel C).

A minimum amount of PPG-mbe per bPEI unit is required to achieve sol-gel (solution to gel) phase transition. In addition, an optimum molar ratio of PPG-mbe per bPEI unit allows the thermogel formed to attain optical transparency and have the lowest critical gelation concentration (CGC) (FIG. 8 and FIG. 9). The resulting hydrogels are held together by non-covalent/supramolecular interactions (i.e. hydrophobic effect) in water which are preferred to covalently crosslinked hydrogels. The non-covalent/supramolecular interactions are preferred as gelation is completely reversible ad inifinitum and no additional chemicals are needed to induce gelation which can cause cytotoxicity.

The various embodiments of the PPG-bPEI polymers described have several unique features. Firstly, it has only PEI (hydrophilic) and PPG (hydrophobic) derivatives and provides a new family of positively charged amphiphilic polymers that are able to form thermogels. Existing thermogelling polymers contain poly(ethylene glycol) (PEG) as the hydrophilic component. Secondly, there is unprecedented ease of tuning the thermogel properties (gelation temperature, mechanical strength, transparency) by varying both the PPG content and bPEI functionalisation. For the latter, adding different chemical groups (e.g. benzyl) can change the degree of charge and their hydrophobicity. This gives a degree of tunability of thermogel properties not easily achieved with existing PEG-containing thermogelling polymers. This allows further modulation of the polymer and gel properties by post-synthetic functionalisation of the bPEI component. Alternatively, the bPEI may be functionalised before combining with the PPG component for a convergent synthesis. It will be appreciated that the bPEI may be functionallised with different aliphatic, aryl and/or aralkyl groups to tune its properties. For example, the bPEI may be quarternised with two or more of aliphatic, aryl and aralkyl groups. Examples of an aliphatic group include alkyl groups like methyl, ethyl, propyl, butyl, and pentyl (including all possible chain isomers like n-propyl, and s-propyl), alkenyl groups like ethylene, alkenyl groups like ethynyl. Examples of an aryl group include phenyl and naphthyl. Examples of an aralkyl group include benzyl, methylnaphthyl, and ethylphenyl. The aliphatic, aryl and aralkyl group may be unsubstituted or substituted. In various embodiments, at least 1 mol % of the amines in the bPEI are quarternised, preferably at least 5 mol %, more preferably at least 7 mol %. In various embodiments, 1 mol % to 50 mol % of the amines in the bPEI are quarternised. In various embodiments, 1 mol % to 30 mol % of the amines in the bPEI are quarternised, preferably 5 mol % to 20 mol % of the amines in the bPEI are quarternised, more preferably 7 mol % to 15 mol % of the amines in the bPEI are quarternised. It is postulated that at higher degrees of quaternisation the copolymers may lose their ability to undergo temperature responsive sol-gel phase transition. With a high amount of quaternisation, the copolymers may experience strong electrostatic repulsion that prevents self-assembly of the copolymers into a supramolecular thermogel matrix.

The flexibility provided here allows the resultant PPG-bPEI copolymer and hydrogel to have its properties optimised and tuned. Thirdly, the PPG-bPEI polymers have dual stimuli-responsiveness and provides an enhanced property profile compared with existing PEG-based thermogels. Other than the aforementioned temperature-responsiveness, the acid-base protonation behaviour of the bPEI segment allows this family of thermogels to be pH-responsive. In other words, gelation behaviour and sol-gel phase transition can be modulated simply by changing the pH at a fixed temperature. This cannot be achieved using PEG containing thermogelling polymers.

### Synthesis of the PPG-PEI Thermogelling Polymers

A series of novel polycationic thermogelling copolymers were synthesised based on conjugating poly(propylene glycol) monobutyl ether (PPG-mbe, 2500 g mol⁻¹) with branched polyethylenimine (bPEI, 25 kDa) via carbonyldiimidazole (CDI) to form urethane linkages (FIG. 1 Panel A). These copolymers may be further quarternised by reaction with benzyl bromide. In Step 1, the free hydroxyl group in PPG-mbe is reacted with carbonyldiimidazole (CDI) to form an intermediate which reacts with branched PEI to give the PPG-bPEI copolymer 10. The PPG-bPEI copolymer 10 may be optionally further alkylated with benzyl bromide to form the quarternised PPG-bPEI copolymer 15 in Step 3.

FIG. 1 Panel B shows a single PPG-bPEI copolymer moiety 10 and a micelle 20 formed of several PPG-bPEI copolymer moieties. FIG. 1 Panel C shows the effect of temperature on the PPG-bPEI micelles 20. Upon heating, the micelles 20 aggregate together to form the gel, and upon cooling dissociates to micelles 20. FIG. 1 Panel D shows the effect of pH on the micelles 20. In low pH or acidic conditions, the micelles 20 are protonated and the aggregated micelles dissociate. Under high pH or basic conditions, the micelles 20 aggregate together.

FIG. 2 shows a picture of a hydrogel where under cold conditions on the left, the aqueous solution is clear and transparent. When the solution is warmed (for example to body temperature), a transparent hydrogel is formed as shown on the right.

FIG. 3 shows a representative schematic structure (Formula I) of the embodiments of the PPG-bPEI polymer composition. FIG. 3 shows the branched PEI component being attached covalently to the PPG-mbe via a urethane (also known as carbamate) functional group, wherein R in Formula I is the PPH-mbe component or hydrogen. The PPG-bPEI copolymer may be optionally further alkylated with benzyl bromide (or another suitable aliphatic group, aryl group or aralkyl group) to possibly form the quarternary ammonium cation. FIG. 3 shows a single quarternary site. The starred nitrogen in FIG. 3 indicates other possible quarterisation sites as an illustration. An amine group circled in FIG. 3 indicates further functionalisation and quarterisation to form cationic groups. The bPEI units are hydrophilic (akin to PEG) and provides water solubility of the PPG-bPEI copolymer. The PPG units enables hydrophobic effect in water to drive micellization and self-assembly to form thermogels. It will be appreciated that the structure in FIG. 3 is merely illustrative in nature due to the nature of the branched PEI where there is no single discrete structure unlike small molecules or linear polymers.

The compositions of the PPG-PEI copolymers may be varied by conjugating different amounts of PPG-mbe units to each PEI unit (Table 1, Table 2). The yields of the purified products range from 50% to 90% with copolymers of lower PPG-mbe content having higher yields. The conjugation efficiency of PPG-mbe to PEI is found to range between 50%-80% of the feed PPG-mbe (Table 1).

### Detailed Synthesis Procedure

### Step 1: Activation of PPG-mbe

The selected amount of polypropylene glycol monobutyl ether (PPG-mbe, number average molecular weight of 2500 g mol⁻¹) was weighed out in a 250 ml round bottom flask and dissolved in anhydrous toluene at a ratio of 2 ml/g of PPG-mbe at 60° C. for 5 mins. Azeotropic distillation was performed on the PPG-mbe solution and repeated. Anhydrous toluene at a ratio of 1 ml/g of PPG-mbe was added and stirred to obtain homogeneous solution.

In a second 250 ml round bottom flask, an equimolar amount of carbonyldiimidazole (CDI) to PPG-mbe was weighed out. The CDI was dissolved in 4 ml of anhydrous DMF at 110° C. 5 mol % of 4-dimethylaminopyridine (DMAP) with respect to PPG-mbe was weighed out and dissolved in 1 ml anhydrous toluene. The solution of DMAP was added to the solution of CDI. The solution of PPG-mbe was subsequently added, and the mixture stirred for 24 h at 110° C. under a dry argon atmosphere.

### Step 2: Conjugation of PPG-Mbe to bPEI

The activated solution of PPG-mbe (activated with CDI) was cooled to room temperature. The required amount of branched PEI (Sigma Aldrich, weight average molecular weight of 25 kDa) was weighed out in a 250 ml round bottom flask and dissolved in anhydrous DMF at a ratio of 6 ml/g of PPG-mbe used. The solution of activated PPG-mbe was added to the solution of bPEI. The mixture was stirred for 3 h at 60° C. under argon atmosphere.

### Step 3: Quarternisation (Optional, if Required)

Benzyl bromide was added to the solution of PPG-bPEI at 10 mol % of the nitrogen atom present. The mixture was stirred for 1 h at 60° C. under an argon atmosphere.

### Step 4: Precipitation and Purification

Hexane and diethyl ether was mixed at a 9:1 volume ratio such that the total volume is 10 times of the volume of the PPG-bPEI solution or benzylated PPG-bPEI solution. The PPG-bPEI solution was poured slowly into the rapidly stirred hexane-diethyl ether solution. The precipitated PPG-bPEI or benzylated PPG-bPEI was allowed to settle to the bottom of the beaker. The supernatant was decanted. The PPG-PEI or benzylated PPG-bPEI was dried at 60° C. under nitrogen gas with slow stirring at 100 rpm for 24 h. The dried PPG-bPEI or benzylated PPG-bPEI was dissolved in methanol at 10 ml/g at 60° C. The PPG-bPEI (or benzylated PPG-bPEI methanol solution was poured into dialysis tubing with a 3.5 kDa cut-off and dialyse against 2 L of deionized water for 3 days with 2 changes of water per day. The resultant mixture was lyophilised to obtain the purified PPG-bPEI or benzylated PPG-bPEI product.

FIG. 4 shows the carbon NMR spectrum of the branched PEI used. The peaks in spectrum are assigned to the representative structure of bPEI as shown in FIG. 4. Based on the spectrum in FIG. 4, it is estimated there are 18.5% of tertiary amines, 35.0% of secondary amines, and 46.5% of primary amines. The degree of branching may be estimated by comparing the integration ratio of tertiary amines to the total number of amines present in a NMR spectrum of the bPEI as it is the tertiary amines that are causing the growth of the branches in bPEI. The secondary amines are simply contributing to the formation of a linear backbone while the primary amines terminate the polymer chain. Thus, the degree of branching in the bPEI used in the examples herein may be estimated to be 18.5% (in other words the percentage of the tertiary amines present based on the NMR spectrum of the bPEI). It is likely that a different percentage of branching the PEI would still produce thermogelling copolymers but may require confirmation experimentally based on the described procedure herein.

TABLE 1
Feed molar ratios of macromonomers, final compositions of PPG-PEI copolymers
by 1H NMR, conjugation efficiencies, molecular weights, and purified yields.

| | | | | Molar | | |
|---|---|---|---|---|---|---|
| | | | | percentage of | | |
| | Feed molar | Final molar | | Nitrogen | | |
| | ratio of | ratio of PPG- | Conjugation | atoms | Molecular | |
| | PPG-mbe | mbe per bPEI | efficiency | quarternised | weight | Yield |
| Sample | per bPEI | conjugated | (%) | (%) | (kDa)* | (%) |
| PCP | 5.00 | 3.35 | 67.0 | NA | 33.4 | 89.1 |
| 3.35 | | | | | | |
| PCP | 10.0 | 7.08 | 70.8 | | 42.7 | 84.7 |
| 7.08 | | | | | | |
| PCP | 15.0 | 11.7 | 78.0 | | 54.2 | 76.5 |
| 11.7 | | | | | | |
| PCP | 25.0 | 17.9 | 71.6 | | 69.8 | 60.2 |
| 17.9 | | | | | | |
| PCP | 45.0 | 32.6 | 72.4 | | 107 | 53.4 |
| 32.6 | | | | | | |
| PCPN | 10.0 | 5.11 | 51.1 | 9.38 | 37.8 | 82.7 |
| 5.11 | | | | | | |
| PCPN | 15.0 | 8.13 | 54.2 | 8.89 | 45.3 | 78.7 |
| 8.13 | | | | | | |
| PCPN | 25.0 | 15.8 | 63.2 | 9.18 | 64.5 | 64.6 |
| 15.8 | | | | | | |
| PCPN | 45.0 | 36.2 | 80.4 | 10.6 | 116 | 57.6 |
| 36.2 | | | | | | |

*Molecular weight is calculated based on the composition of the copolymers determined by NMR.

### Ppg-bPEI Polymer Characterisation

The compositions of the synthesized copolymers are first determined by nuclear magnetic resonance (NMR) spectroscopy. FIG. 5 shows an example of a NMR spectrum of a benzylated PPG-bPEI copolymer (PCPN15.8). The broad peak at δ=2.36-2.97 ppm corresponds to the protons in the bPEI macromonomer, while the peaks at δ=1.04-1.15 ppm and δ=3.38-3.62 ppm corresponds to the PPG-mbe macromonomer, and the peak at δ=7.17-7.42 ppm arises from the appended benzyl group. The NMR spectra confirm the successful synthesis and quarternisation of the PPG-PEI copolymers. Table 2 and FIG. 5 illustrates the procedure of determining the composition of each component in the copolymers, using PCPN15.8 as an example.

TABLE 2
Composition determination via integration ratios from representative
1H NMR of poly(PPGmbe/PEI urethane) copolymer (PCPN 15.8).

| | PPG- | PEI | Benzyl |
|---|---|---|---|
| Identity | mbe | Branched | bromide |
| Mass of (macro)monomer | 2500 | 25000 | 171 |
| (g mol⁻¹) | | | |
| Mass of repeating unit | 58 | 473 | 171 |
| (g mol⁻¹) | | | |
| No. of repeating units | 41.8 | 52.8 | 1 |
| No. of protons in | 3 | 46 | 5 |
| repeating unit for | | | |
| the NMR peak of interest | | | |
| No. of protons per | 130 | 2430 | 5 |
| (macro)monomer | | | |
| for that NMR peak | | | |
| Relative NMR integrals (from | 0.85 | 1 | 0.11 |
| spectrum) | | | |
| Mole ratio of | 0.00651 | 0.000411 | 0.0220 |
| (macro)monomers | | | |
| Normalised mole | 15.8 | 1 | 53.5 |
| ratio (PEI set to 1) | | | |

| | |
|---|---|
| % N atoms on PEI | 9.18 |
| quarternised | |

### Thermogels Made of PPG-bPEI Polymers

The synthesised PPG-bPEI copolymers were dissolved in deionized water at low temperatures (4° C.) for 24h to form micellar sols and most of these sols were observed to undergo sol-gel phase transitions when heated above their gelation temperatures. This sol to gel phase transition is brought about by the micellization of the PPG-PEI copolymers and the further self-assembly of the micelles into supramolecular hydrogel network (FIG. 1 Panel B). During this process, the thermosensitive PPG-mbe units dehydrates and aggregates together via hydrophobic interactions, and this is observed as the broadening of the PPG-mbe peaks during a proton NMR temperature sweep of the PPG-bPEI copolymers in D₂O as shown in FIG. 6.

A minimum amount of PPG-mbe is required to be conjugated to bPEI for the micellar sol to achieve transition to the gel phase when heated. In other words, at PPG-mbe ratios lower than the threshold, the micellar sol remains in the sol phase and does not transit to the gel phase even at polymeric concentrations as high as 20 wt % (FIG. 7). FIG. 7 shows the samples of PCP 3.35 and PCPN 8.13 at 20 wt % are unable to achieve sol-gel phase transition as their PPG-mbe content per unit PEI are below the minimum thresholds. Even at a pH of 12, both samples do not form a gel. The threshold for non-quarternised PPG-bPEI copolymers was above 3.35 PPG-mbe units per unit of bPEI, in particular between 3.35 to 7.08 PPG-mbe units per unit of bPEI. For quarternised PPG-bPEI copolymers (PPG-bPEI+), this threshold is higher due to the electrostatic repulsion between micelles arising from the cationic PEI segments. As such, the threshold for gelation of PPG-bPEI+ copolymers was found to be above 8.13 PPG-mbe units per unit of bPEI, in particular between 8.13 to 15.8 PPG-mbe units per bPEI unit.

FIG. 8 shows the gels formed by the other samples. It was observed that PCP17.9 formed gels with the highest optical transparency. In addition to the lower threshold, there also exist an optimum range of PPG-mbe units per bPEI units such that they produce thermogels with the lowest critical gelation concentration (CGC) as shown in FIG. 9. The top and bottom phase diagrams in FIG. 9 are at pH 12 and pH 7 respectively. The thermogels formed by PPG-bPEI copolymers below or above the optimum range are generally translucent or opaque as shown in FIG. 8. For unquarternised PPG-bPEI thermogels, the optimum PPG-mbe ratio per bPEI unit is found to be around 18, as demonstrated by PCP 17.9 having the lowest CGC (7 wt % at pH 12 and 8 wt % and pH 7) (left most curve in the phase diagrams).

The CGCs of the unquarternised PPG-bPEI thermogels lowers with increasing PPG-mbe content but increases again once the PPG-mbe content exceeds the optimum ratio as shown in FIG. 9. These cationic PPG-bPEI thermogels are observed to not collapse even at temperatures close to 100° C. The CGC of PCP 7.08 at pH 12 is 12 wt % and decreases to the lowest value of 7 wt % for PCP 17.9. However, beyond the optimum PPG-mbe content, the CGC increased back to 12 wt % for PCP 32.6. Similarly, at pH 7, while the CGC of PCP 7.08 is at 13 wt %, it decreased to 8 wt % for PCP 17.9 but increased back to 13 wt % for PCP 32.6. It is postulated that the optimal PPG-mbe content exists because at high PPG-mbe content the hydrophobic interactions between the copolymers would be extensive and cause the formation of large aggregates which do not contribute to efficient self-assembly of the micelles into a supramolecular hydrogel matrix. The formation of large light scattering aggregates is supported by the opaque gels formed by PCP 32.6 seen in FIG. 8.

On the other hand, the CGCs of the quarternised PPG-bPEI gels are more complex as their self-assembly are determined by the combined effects of hydrophobic interactions between the PPG-mbe segments and electrostatic repulsion between the positively charged PEI units. PCPN 15.8 and PCP 17.9 have similar PPG-mbe content, but due to the higher electrostatic repulsion experienced by the copolymers of PCPN 15.8, its thermogel is observed to have a much higher CGC of 14 wt % at pH 12 as compared to PCP 17.9 with a corresponding CGC of 8 wt % (FIG. 9). However, while PCPN 36.2 and PCP 32.6 have similar PPG-mbe content and PCPN 36.2 is quarternised, the opposite phenomenon was observed where PCPN 36.2 has the lower CGC of 10 wt % at pH 12 as compared to 13 wt % for PCP 32.6 (FIG. 9). The highly opaque thermogels formed by PCP 32.6 suggest the formation of large hydrophobic aggregates that possibly led to poor self-assembly of micelles. It is possible that with quarternisation, the electrostatic repulsion balanced out the hydrophobic interactions between copolymers and resulted in more efficient micelle packing, and thus resulted in PCPN 15.8 having a lower CGC than PCP 17.9.

In addition to temperature responsiveness, these cationic PPG-bPEI thermogels also have pH responsiveness arising from their bPEI segments. Due to the basicity of the PEI units, these PPG-bPEI copolymers initially dissolve in water to form alkaline sols (pH typically 9 to 11). The greater propensity of the bPEI segments to be protonated at lower pH increases the positive charge on the polymers and leads to greater electrostatic repulsion between the micelles, resulting in higher gelation temperatures and CGCs. FIG. 10 shows the phase diagrams of PCP 17.9 at different pH values. The CGC of PCP 17.9 slightly increased from 7 wt % to 8 wt % when the pH is decreased from 12 to a pH value of 3. In addition, the gelation temperature of the PCP 17.9 8 wt % thermogel increased from 17° C. at pH 12 to 30° C. at pH 3.

In addition to the phase diagrams obtained from tube inversion, the storage moduli of the PPG-bPEI thermogels at 15 wt % and pH 7 are also measured by oscillatory temperature sweep rheology from 5° C. to 40° C. at 3° C. per minute at 1% strain and 1 Hz. At low temperatures in the sol state, the storage modulus (G′) of the thermogel solution is lower than the loss modulus (G″). With the gradual temperature ramp, both storage and loss moduli are observed to increase with the storage modulus exceeding the loss modulus at the gelation temperature as shown in FIG. 11.

Across the unquarternised PPG-PEI thermogels, the storage moduli at 37° C. was observed to increase with increasing PPG-mbe relative bPEI, from 40.5 Pa of PCP 7.08 to 375 Pa of PCP 17.9 as shown in FIG. 12, plotted line 115. However, the storage modulus decreased significantly when PPG-mbe content exceeded the optimal amount with PCPN 32.6 having a storage modulus of only 50.0 Pa. Due to quarternisation and increased electrostatic repulsion, PCPN 15.8 has a much lower storage modulus of 74.6 Pa as compared to PCP 17.9. However, PCPN 36.2 has a much higher storage modulus of 480 Pa as compared to its unquarternised PCP 32.6 counterpart.

The copolymer compositions and formed gels may be used with antimicrobial agents effective against bacteria, fungi, and viruses. For example, the gel may be used as an antimicrobial rheological modifier in creams and emollients. Some preliminary testing indicate that minimum inhibitory concentration (MIC) of 100 μg/mL against E. coli bacteria is achievable. The gel may also be used for gene delivery from a localised injectable in-vivo depot for gene therapy and sustained delivery of small molecule or protein-based drugs from a localised depot. The copolymer composition and gel contain an abundance of amine groups which may allow them to be used in carbon dioxide capture and recovery and recycling of metals from electronic waste. For example, copper from printed circuit boards. This may be by the amine complexing with the Cu²⁺ ion.

The branched polyethylenimine used in the embodiments herein has distinct differences from PEG used in existing thermogels. The bPEI has different extent of hydration compared to PEG, and has a branched structure compared to the linear structure of PEG. The different make-up and architecture of the bPEI-PPG copolymers are markedly different from existing thermogelling polymers, especially those based on PEG.

Cationic polymers such as Poly(2-(dimethylamino)ethyl methacrylate) (PDMAEMA) and poly(beta-amino esters) (PBAE) have been employed in the literature to replace PEG, while temperature responsive hydrophobic polymers such as poly(lactic-co-glycolic acid) (PLGA), polylactic acid (PLA), Poly(N-isopropylacrylamide) (PNIPAAM), and polypeptides have been used to replace PPG. However, an overwhelming majority of the copolymers produced by conjugating these cationic polymers and hydrophobic polymers do not produce thermogelling copolymers. In contrast, the combination of bPEI and PPG in the copolymer compositions described herein provides a composition which is able to form a thermogel and further has the advantage of being pH responsive.

In conclusion, the synthesis, formulation, and characterisation of the first cationic bPEI derived pH and temperature responsive supramolecular hydrogel has been described. The properties of these cationic polyelectrolyte supramolecular gels are highly dependent on their composition in terms of hydrophobic-hydrophilic balance and degree of quarternisation. These cationic polyelectrolyte thermogels have high unexplored biomedical application potential as they combine in synergy the unique advantages of thermogels with the unique properties of PEI-derived cationic micelles.

### REFERENCES

[1] Y. S. Zhang, A. Khademhosseini, Science 2017, 356.
[2] A. Mandal, J. R. Clegg, A. C. Anselmo, S. Mitragotri, Bioengineering & Translational Medicine 2020, 5, e10158.
[3] K. Zhang, K. Xue, X. J. Loh, Gels 2021, 7, 77.
[4] J. Qu, X. Zhao, P. X. Ma, B. Guo, Acta biomaterialia 2018, 72, 55-69.
[5] T. Nguyen, J. J. Magda, P. Tathireddy, Sensors and Actuators B: Chemical 2018, 255, 1057-1063.
[6] Y. Chen, H. Song, K. Huang, X. Guan, Food & Function 2021, 12, 9165-9177.
[7] R. Wang, M. Zhang, Y. Guan, M. Chen, Y. Zhang, Soft matter 2019, 15, 6107-6115.
[8] (a) S. Chatterjee, P. C.-I. Hui, Polymers 2021, 13, 2086; (b) S. Chatterjee, C.-L. Hui, Molecules 2019, 24, 2547.
[9] Q. Lin, C. Owh, J. Y. Lim, P. L. Chee, M. P. Yew, E. T. Hor, X. J. Loh, Accounts of Materials Research 2021.
[10] S. Cui, L. Yu, J. Ding, Macromolecules 2018, 51, 6405-6420.
[11] S. S. Liow, Q. Dou, D. Kai, A. A. Karim, K. Zhang, F. Xu, X. J. Loh, ACS Biomaterials Science & Engineering 2016, 2, 295-316.
[12] Z. Liu, S. S. Liow, S. L. Lai, A. Alli-Shaik, G. E. Holder, B. H. Parikh, S. Krishnakumar, Z. Li, M. J. Tan, J. Gunaratne, Nature biomedical engineering 2019, 3, 598-610.
[13] M. Y. Marzbali, A. Y. Khosroushahi, Cancer chemotherapy and pharmacology 2017, 79, 637-649.
[14] L. Zhou, P. Zhang, Z. Chen, S. Cai, T. Jing, H. Fan, F. Mo, J. Zhang, R. Lin, International journal of nanomedicine 2017, 12, 4269.
[15] H. Wang, S. Ding, Z. Zhang, L. Wang, Y. You, The journal of gene medicine 2019, 21, e3101.
[16] Y. Dai, X. Zhang, Journal of Nanoparticle Research 2017, 19, 164.

1. A composition comprising branched polyethylenimine and polypropylene glycol covalently bonded to the branched polyethyleneimine, wherein a molar ratio of the propylene glycol to the branched polyethylenimine is more than 3.35:1, and the polypropylene glycol is hydrophobic and has mole average weight of at least 500 Da, the branched polyethylenimine has a weight average molecular weight of at least 500 Da.

2. The composition according to claim 1, wherein a first end of the propylene glycol is capped with an aliphatic group, an aryl group, or an aralkyl group in any combinations thereof, and a second end of the propylene glycol is covalently bonded to the branched polyethylenimine.

3. The composition according to claim 2, wherein the propylene glycol is capped with the aliphatic group, preferably a C1 to C6 alkyl group.

4. The composition according to claim 1, wherein the propylene glycol has a number average molecular weight from 500 Da to 20 kDa, preferably the polypropylene glycol has a number average molecular weight from 1 kDa to 10 kDa.

5. (canceled)

6. The composition according to claim 1, wherein the branched polyethylenimine has a weight average molecular weight from 500 Da to 50 kDa, preferably from 5 kDa to 50 kDa.

7. The composition according to claim 6, wherein the branched polyethylenimine has a weight average molecular weight from 10 kDa to 40 kDa.

8. The composition according to claim 1, wherein the branched polyethylenimine has a degree of branching from 5% to 50%.

9. The composition according to claim 1, wherein the polypropylene glycol is covalently bonded to the branched polyethyleneimine via a functional group selected from the group consisting of a carbamate, a carbonate, a carbamide, an ester, an amide, an ether, an amine, a triazole, and any combinations thereof, preferably the carbamate, the amide, the ether, the amine, the triazole, and any combinations thereof.

10. The composition according to claim 1, wherein the molar ratio of propylene glycol to polyethylenimine is from more than 3.35:1 to 40:1.

11. The composition according to claim 10, wherein the branched polyethylenimine is unquarternised, and the molar ratio of propylene glycol to branched polyethylenimine is from 7:1 to 35:1, more preferably the molar ratio is from 10:1 to 25:1 or from 15:1 to 20:1 or from 17:1 to 19:1.

12. (canceled)

13. The composition according to claim 1, wherein the branched polyethylenimine comprises from 1 mol % to 50 mol % of nitrogen atoms quarternised with a second aryl group, a second aliphatic group, or a second aralkyl group in any combinations thereof, and the molar ratio of propylene glycol to polyethylenimine is more than 8.13:1, preferably the polyethylenimine comprises 1 mol % to 30 mol % of nitrogen atoms quarternised.

14. The composition according to claim 13, wherein the molar ratio of propylene glycol to branched polyethylenimine is from more than 8.13:1 to 60:1, preferably the molar ratio is from 15:1 to 60:1, more preferably the molar ratio is from 15:1 to 50:1, even more preferably the molar ratio is from 15:1 to 40:1.

15. The composition according to claim 1, wherein the composition essentially excludes polyethylene glycol.

16. The composition according to claim 1, further comprising a third polymer up to 20 weight percent of the composition, wherein the third polymer is different from polyethylenimine and polypropylene glycol.

17. The composition according to claim 1, wherein branched polyethylenimine and polypropylene glycol are the only polymers present, preferably the composition consists essentially of branched polyethylenimine and polypropylene glycol.

18. The composition according to claim 1 further comprising water, and preferably a buffer solution.

19. (canceled)

20. The composition according to claim 18 further comprising at least one of the following: a therapeutic agent, a protein, and a nucleic acid sequence.

21. A method of capturing carbon dioxide the method comprises capturing carbon dioxide with the composition according to claim 1.

22. A method of recovering a metal from waste, the method comprises recovering the metal from waste with the composition according to claim 1.

23. The composition according to claim 9, wherein the functional group is the carbamate.
